(19) United States
(12) Patent Application Publication
(10) Pub. No.: US 2026/0195558 A1
(43) Pub. Date: Jul. 9, 2026

(54) WIRELESS DATA COLLECTION SYSTEM

(71) Applicants: SAFRAN HELICOPTER ENGINES, BORDES (FR); SAFRAN ELECTRONICS & DEFENSE, PARIS (FR)

(72) Inventors: Fabien LAMAZERE, MOISSY-CRAMAYEL (FR); Mathieu ERACARRET, MOISSY-CRAMAYEL (FR); Nicolas FANTON, MOISSY-CRAMAYEL (FR)

(21) Appl. No.: 19/130,491

(22) PCT Filed: Nov. 8, 2023
(86) PCT No.: PCT/EP2023/081102

§ 371 Date: May 15, 2025

(30) Foreign Application Priority Data
Nov. 15, 2022 (FR) FR2211886

(51) Int. Cl. G06K 19/07; B64C 27/04; B64D 45/00; G08C 17/00; H01Q 1/22

(52) U.S. Cl. CPC G06K 19/0717; B64C 27/04; B64D 45/00; G08C 17/00; H01Q 1/2216; B64D 2045/0085

(57) ABSTRACT

An electromagnetic signal-based data collection system includes a collector provided with a first antenna having a predetermined bandwidth and at least one remote electronic device including a second antenna having a second bandwidth that coincides with the first bandwidth for exchanging signals with the first antenna. The remote electronic device includes a thermal protection envelope surrounding at least the second antenna and defining a cavity around the latter so that the second antenna radiates signals outside the protective envelope substantially in the second bandwidth.

The present invention concerns the field of collecting data, in particular in vehicles, for example collecting data in a hot environment such as the engine compartment of a vehicle.

### BACKGROUND OF THE INVENTION

Motor vehicles include an engine accommodated in an engine compartment that is insulated to a greater or lesser extent, in particular thermally insulated and sound insulated, from the rest of the vehicle, in which there is an engine control station. To control the operation of the engine and/or for its maintenance it is necessary to recover a certain amount of information relating to the engine such as for example temperature, impact and vibration data and configuration information (for example the product number P/N and the serial number S/N).

Where the recovery of data relating to the operation of the engine is concerned one classic solution is to dispose sensors in the engine compartment and to connect them by electrical cables to the control station that collects the data in question. However, using cables increases the weight of the vehicle and therefore its energy consumption and proves to be a relatively significant constraint in terms of vehicle design.

One classic solution for collecting configuration information is to keep up to date in an information system outside the vehicle a list of the replaceable components used (known as line-replaceable units (LRU) ). However, copying the P/N and S/N data entails work and consequently errors (failure to respect the potential service life of an LRU or use of a non-standard configuration).

Moreover, in other fields of day to day life, such as for example packaging and tracking parcels, it is known to collect data using the RFID (radiofrequency identification) technology. That technology is implemented by means of systems comprising a reader and RFID tags. The reader includes a first electronic circuit including a first integrated circuit connected to a first antenna having a first bandwidth and each RFID tag includes a second electronic circuit including a second integrated circuit connected to a second antenna having a second bandwidth virtually identical to the first bandwidth. The first electronic circuit of the reader therefore communicates with the second electronic circuit by exchanging electromagnetic signals. RFID tags are relatively fragile and very sensitive to heat.

### OBJECT OF THE INVENTION

The invention has in particular for object enabling collection of data such as identifying data in a relatively hot environment and limiting the weight of the equipment necessary for such collection.

### SUMMARY OF THE INVENTION

To this end, the invention provides an electromagnetic signal-based data collection system including on the one hand a collector provided with a first antenna having a predetermined bandwidth and on the other hand at least one remote electronic device including a second antenna having a second bandwidth that coincides with the first bandwidth for exchanging signals with the first antenna. The device includes a thermal protection envelope surrounding at least the second antenna and defining a cavity around the latter so that the second antenna radiates signals outside the protective envelope substantially in the second bandwidth. It is therefore possible to collect the data without using electric cables but ensuring reliable transmission of the data. However, to protect the antenna from heat the antenna is surrounded by a thermal protection envelope. Now, this envelope could degrade the properties of the antenna. To remedy this the envelope defines around the antenna a cavity enabling the antenna to radiate into the free space of the cavity. The thickness of the thermal protection envelope of the antenna can be limited so that the envelope can provide its thermal protection function without significantly degrading the radiation from the antenna. The invention is suitable for use in the environment of a combustion engine at temperatures between 100° C. and 250° C. or even higher.

The invention also concerns a vehicle including a propulsion engine disposed in an engine compartment and at least one remote device of such a system, the remote device being fixed in the engine compartment.

Other features and advantages of the invention will emerge on reading the following description of particular non-limiting embodiments of the invention.

### BRIEF DESCRIPTION OF THE DRAWINGS

Reference will be made to the appended drawings, in which:

FIG. 1 is a schematic partial perspective view of an aircraft equipped with a system according to the invention more particularly showing an engine compartment of that aircraft;

FIG. 2 is a block diagram of a data collection system according to the invention;

FIG. 3 is a schematic view of a remote device of said system according to a first embodiment of the invention in section on a plane parallel to a substrate of an electronic circuit of the remote device;

FIG. 4 is a schematic view of that remote device in section on a plane perpendicular to the substrate of the electronic circuit of the remote device;

FIG. 5 is a view analogous to FIG. 3 of a remote device according to a second embodiment of the invention.

### DETAILED DESCRIPTION OF THE INVENTION

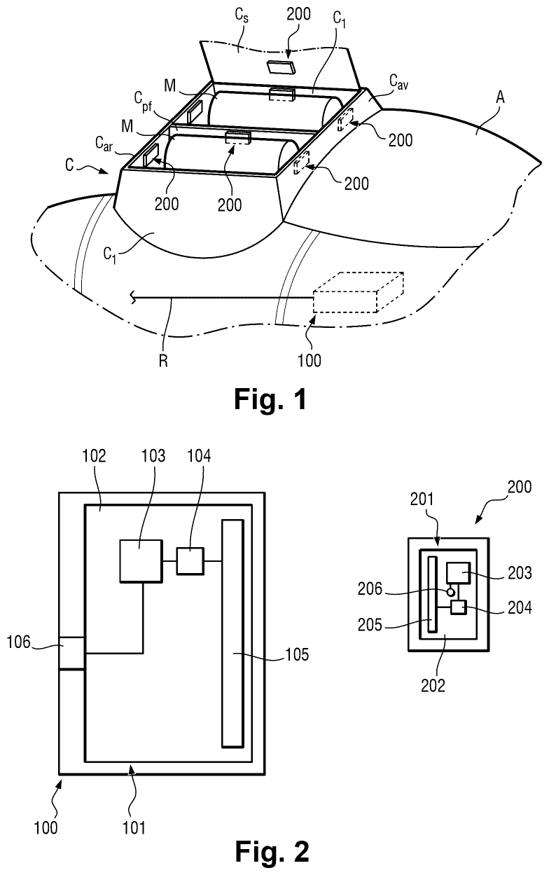

Referring to FIG. 1, the invention is described here in an application to an aircraft A including two engines M in the same engine compartment C. The engine compartment C includes a front bulkhead Cav, a rear bulkhead Car, two side bulkheads C1 and a fire bulkhead Cpf separating the two engines M from one another. The engine compartment C includes an opening at the top closed by a top hatch Cs. Referring to FIG. 2, the system according to the invention includes a data collector (or reader) generally designated 100 and, here, a plurality of remote electronic devices 200.

The collector 100 includes an electronic circuit 101 that includes a printed circuit 102 carrying an integrated circuit 103 and a transmitter/receiver 104 connected by a connecting cable to an antenna 105 (or first antenna) that is separate from the electronic circuit 101. The integrated circuit 103 includes a processor and a memory containing data and a program that can be executed by the processor. The printed circuit 102 further includes at least one connector 106 for connecting the electronic circuit 101 to an avionic network R of the aircraft A. The antenna 105 is tuned to a frequency band (or first bandwidth) that is part of the frequency band used for RFID devices. Here the collector 100 is onboard the aircraft: the electronic circuit 101 is outside the engine compartment c; the antenna 105 is inside the engine compartment.

Each remote device 200 includes an electronic circuit 201 that includes a printed circuit 202 carrying an integrated circuit 203 and a transmitter/receiver 204 connected to an antenna 205 tuned to a second frequency band (or second bandwidth) to be able to communicate with the collector 100 as described below. The antenna 205 thus has a second bandwidth coinciding with the first bandwidth. By “coincides” is meant that each of the two bandwidths overlaps the other over at least one third or even over half this frequency band, or even more depending on the required reliability of transmission. Here the bandwidth extends between −3 dB and +3dB around the frequency corresponding to the maximum power of the signals transmitted.

The integrated circuit 203 includes a processor and a memory containing data and a computer program that can be executed by the processor. The remote device 200 can provide at least one of the following functions:
a function of storing an identification of the component to which it is fixed;
a function of storing parameters or a configuration of the component to which it is fixed;
a function of measuring and storing an environmental parameter of the component to which it is fixed.

To this end the electronic circuit 201 of the remote device 200 is connected to a sensor 206 (for example a temperature, impact, vibration or pressure sensor).

The remote device 200 is a passive type RFID device in that it does not include a battery and is powered by the energy of the signals that it receives via the antenna 205. This is a classic way of supplying RFID devices with energy.

The remote device 200 includes a thermal protection envelope in which at least the antenna 205 is housed, here also the whole of the electronic circuit 201. The remote device 200 also includes means for compensating any influence of the thermal protection envelope on the electromagnetic signals exchanged between the two antennas 105, 205. The compensation means is such that the electromagnetic signals transmitted in the first bandwidth by the antenna 105 are received in the second bandwidth by the antenna 205 and vice versa.

The collector 100 can therefore recover the stored data by interrogating the remote device 200. Collection is initiated by the collector 100, which sends a request signal containing a data request (for example an identification data request) and the electronic circuit 201 of the remote device 200, supplied with energy by the request signal, transmits an identification signal containing the identifier of the component to which it is fixed before sending:
a data signal containing the other data contained in its memory,
an identification signal containing a transponder ID (TID).

The electronic circuit 101 of the collector 100 is programmed to collect data automatically before each flight, during the flight or after the flight. The electronic circuit 101 of the collector 100 can be programmed to collect data periodically or only once. The data recovered by the collector 100 is then transmitted to a predictive maintenance system, for example via the avionic network R or via an RFID connection initiated with a reader used by a maintenance operative. The data recovered by the collector 100 can be stored in the memory of the collector 100 or in a memory connected to the avionic network R.

It will be noted that the collector 100 can also be programmed to update data stored in the electronic circuit 201 of the remote device 200, such as:
the identifier of the component with which the remote device 200 is associated,
a configuration or parameters of the component with which the remote device 200 is associated,
the value of an alert threshold,
the value of a control threshold for the storage or transmission of the parameter measured by the remote device 200. For example, in this latter case when applied to a remote device 200 for measuring temperature, the temperature is not stored or is not transmitted if it is below the threshold value. Furthermore, the temperature can be used to extend the service life of the remote device 200. In effect, if a remote device 200 when interrogated is at too high a temperature there is a risk of reading it prematurely. It is therefore preferable for the remote device 200 not to respond to an RFID request if its internal temperature is too high.

The device includes a thermal protection envelope surrounding at least the antenna 205 and defining a cavity around the latter. This makes it possible to reduce or even to eliminate an offset of the bandwidth of the antenna caused by the presence of the protective envelope. The thermal protective envelope has around the antenna 205 a thickness that can if necessary be adjusted so as further to reduce this frequency offset. Be this as it may, the antenna radiates signals outside the protective envelope substantially in the second bandwidth.

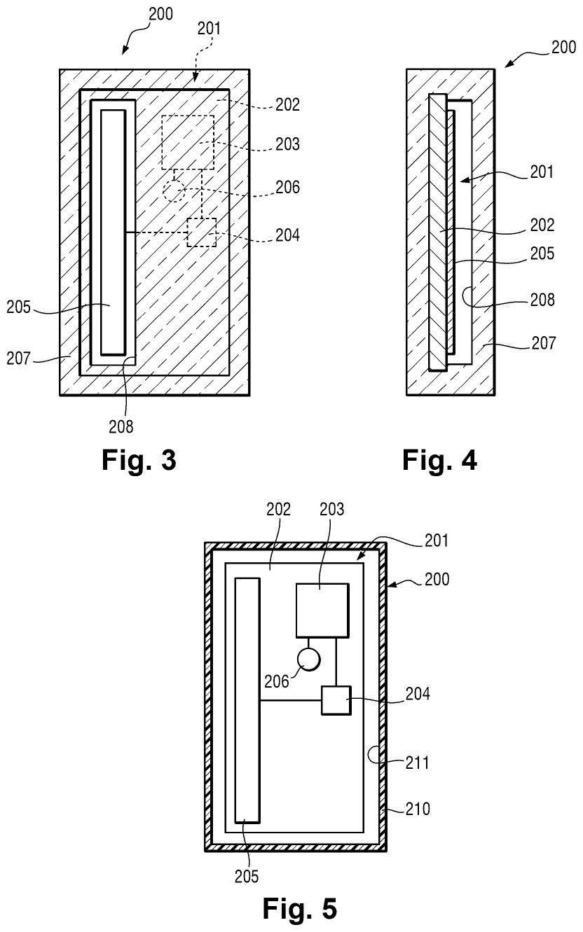

As represented in FIGS. 3 and 4 the first embodiment of the thermal protection envelope 207 includes a block of polymer resin defining a cavity 208 in which the antenna 205 extends and enables the antenna 205 to resonate in the area of the cavity 208. The cavity 208 then forms a compensation means enabling limitation of the influence of the thermal protection envelope on the bandwidth of the antenna 205. The volume of this cavity 208 can be determined as a function of the compensation to be applied. The thickness of the protective envelope is determined as a function of the thermal conductivity of the thermal protection envelope (207; 210) and a surrounding temperature estimated in operation. To be more precise the thickness of the block of polymer resin forming the thermal protection envelope 207 around the cavity 208 is determined as a function of:
the thermal conductivity of the polymer resin,
the maximal temperature that the electronic circuit 201 and more particularly the antenna 205 can withstand,
the maximal outside temperature and, possibly,
a safety coefficient.

The thickness also depends on the mechanical strength capabilities required for the resin to provide a mechanical protection function suitable for the environmental conditions of the remote device 200.

Here the polymer resin chosen is a silicone resin that can be vulcanized at room temperature, known as a room temperature vulcanizable (RTV) resin. The following RTV polymer resins can be used: RTV 160, RTV 162, RTV 167, RTV 511, RTV 560, RTV 577. It will be noted that the polymer resin chosen here is free of metal particles, metal particles being opaque to electromagnetic radiation. For materials of this type outside the zone in which the cavity is situated the thickness of the protective envelope can then be between 0.5 cm and 5 cm for example. Here the thickness of the protective envelope at the level of the cavity is lower than in the rest of the printed circuit.

The thickness of the envelope at the level of the cavity in a direction perpendicular to the printed circuit can be less than the thickness of the cavity itself in that direction or even less than half the thickness of the cavity.

The thickness of the cavity is for example between 0.3 cm and 2 cm.

The thermal protection envelope 207 is produced by molding with the electronic circuit 201 disposed in a mold including rods supporting the electronic circuit 201 at a distance from the walls of the mold and a cap placed on the antenna 205 to delimit the cavity 208 (the cap can be manufactured by additive manufacture) and pouring the polymer resin in liquid form into the mold so that it encapsulates the whole of the electronic circuit 201, the cap forming a lost mold portion. The mold is then positioned on a planetary mixer to favor release of any air bubbles trapped in the liquid resin before being placed in a low-temperature (50-60° C.) oven to assist hardening of the polymer resin. After hardening the remote device 200 is removed from the mold and the holes left by the rods and the volume linked to shrinkage of the resin on drying being filled with resin and allowed to harden. Operations of deburring, surfacing and etching can therefore be carried out where necessary. To facilitate evacuation of the bubbles of air it is also possible to carry out molding in a vacuum enclosure instead of or in addition to the use of a planetary mixer. Furthermore, if the polymer resin has sufficient hardness tubes for the passage of screws can be mounted in the mold before pouring the resin to enable the remote device 200 to be fixed onto a plate 250 by inserting screws into the tubes and screwing them into threaded holes in the plate.

In an alternative method of manufacture successive premolded layers can be used at least one of which includes a reserve to form the enclosure 207 and that are stacked on one another until the electronic circuit 201 is completely encapsulated. The layers can be fixed together by gluing for example or by fixing the stack onto a plate by screws clamping the stack onto the plate and the layers against one another.

As represented in FIG. 5 a second embodiment of the thermal protection envelope 210 is made of ceramic and here more specifically of silicon nitride. As before a cavity 211 is delimited by the thermal protection envelope 208 around the antenna 205 and here also around the whole of the electronic circuit 1. The thermal protection envelope 210 can cause losses by reflection linked to the relative permittivity of the protection envelope 210 and losses by dissipation in the ceramic because of the loss tangent. Its form, its thickness and the ceramic used are determined in such a manner as to limit this influence while offering the required thermal protection. More precise compensation could be obtained by taking account of other possible influences, such as deterioration of the directivity of the antenna 205 (increased side lobes for example), mismatching of the antenna (increased voltage standing wave ratio), antenna pointing errors, depolarization, etc. The compensation mean is not limited to making good a frequency offset and can be adapted to compensate other faults if necessary (compensation of defects in the manufacture of the circuit forming the antenna).

In the preferred embodiment of the invention the system includes a plurality of remote devices 200 distributed in the engine compartment C, namely:
at least one on the front bulkhead Cav,
at least one on the rear bulkhead Car,
at least one on the top hatch Cs,
at least one on the fire bulkhead Cpf.

To improve the transmission of signals there may be provided wave deflector metasurfaces fixed to the bulkheads Cav, Car, Cs and/or Cpf and/or the hatch Cs to direct the waves coming from the antenna 205 to the collector 100 and vice versa. The metasurfaces are surfaces reflecting the waves at a given frequency, here that of the RFID signals. They can be designed to reflect these waves in a directed manner. At least one of metasurfaces can be encapsulated/buried in a thermal protection material like the antenna 205.

Of course, the invention is not limited to the embodiment described but encompasses any variant within the scope of the invention as defined by the claims.

In particular, the remote device can have a structure different from that described.

The thermal protection block/envelope can be disposed around the antenna alone, the antenna being connected by a cable or a connector to the rest of the electronic circuit. Other polymer resins can be chosen to form the thermal protection envelope, for example an epoxy resin or a PG 231 or PG 355 resin. The temperature range of use will preferably be from −40° C. (even −60° C.) to +150° C. (even higher and beyond 250° C.) and the thermal conductivity less than 1 W/ (m. K). There will furthermore preferably be chosen as hard as possible a resin with a Shore D hardness at least equal to 30 to provide mechanical protection of the antenna of the electronic circuit.

Other ceramics can be chosen to form the thermal protection envelope, for example a glass ceramic.

The material of the thermal protection block/envelope will preferably be chosen as a function of its performance in terms of radiowave transmission.

The invention can also be applied to active type RFID devices, that is to say devices including a battery to power the electronic circuit, for applications at temperatures preferably below 200° C.

The remote device 200 can be adapted to provide functions other than those indicated and for example one or more functions for estimating a service life of the component with which it is associated, such as:
incrementing a counter each time that the remote device 200 is read by the collector 100 on the hypothesis that a reading is carried out after each operating cycle;
incrementing a counter for a specific RFID command used each time the engine is started to count the number of cycles for which the engine functions;
measuring a temperature by means of an integrated temperature sensor to count the number of cycles or even the operating time of the LRU (which presupposes that the remote device 200 is powered continuously to measure and process temperature information, either because the antenna 205 is subjected at all times to radiofrequency radiation or because the remote device 200 incorporates a battery);
measuring acceleration by means of an integrated accelerometer to count the number of cycles or even the operating time of the LRU (which presupposes that the remote device 200 is supplied with power continuously to measure and process the acceleration information, either because the antenna 205 is subjected continuously to radiofrequency radiation or because the remote device 200 incorporates a battery). The remote device can have a much more basic structure than the one described and include only passive components.

The antenna may have a structure different from that described and based on any electrically-conductive element such as a printed circuit track, a cable, a busbar or metasurface.

There are two ways to identify the component to which the remote device 200 is associated:
either the S/N and P/N data is stored in the memory of the remote device 200 as described above;
or the collector 100 covers the transponder identifier (TID) of the remote device 200 (this identifier is specific to each RFID device) and it is the information system that establishes the correspondence between the TID, the P/N and the S/N. The first solution is a simpler way to recover the P/N and the S/N. The second solution is less costly in terms of energy, the TID being more directly accessible (which is important if the remote device 200 is at the limit of the ranges of the RFID antennas and therefore has little energy).

The collector can be onboard the aircraft or independent of the aircraft and used on the ground by a maintenance operative.

The invention can be applied to vehicles of any type, such as land, sea or air vehicles, whether or not there is a crew. In the case of air vehicles, the invention can be applied to fixed or rotating wing aircraft whatever the number of engines that they include.

1. An electromagnetic signal-based data collection system including on the one hand a collector provided with a first antenna having a predetermined bandwidth and on the other hand at least one remote electronic device including a second antenna having a second bandwidth that coincides with the first bandwidth for exchanging signals with the first antenna, wherein the device includes a thermal protection envelope surrounding at least the second antenna and defining a cavity around the latter so that the second antenna radiates signals outside the protective envelope substantially in the second bandwidth.

2. The system as claimed in claim 1, wherein a thickness of the protective envelope is determined as a function of a thermal conductivity of the thermal protection envelope and a surrounding temperature estimated during operation.

3. The system as claimed in claim 1, or wherein the thermal protection envelope is made of a polymer resin.

4. The system as claimed in claim 3, wherein the polymer resin has a thermal conductivity less than 1 W/(m.K).

5. The system as claimed in claim 3, wherein the polymer resin is a silicone resin or an epoxy resin.

6. The system as claimed in claim 1, wherein in the thermal protection envelope is made of ceramic.

7. The system as claimed in claim 6, wherein the ceramic is silicon nitride or a glass ceramic.

8. A vehicle including a propulsion engine disposed in an engine compartment and at least one remote device of a system as claimed in claim 1, the remote device being fixed in the engine compartment.

9. The vehicle as claimed in claim 8 consisting of an aircraft.

10. The vehicle as claimed in claim 9, wherein the aircraft is of the helicopter type.
